(19) United States
(12) Patent Application Publication
(10) Pub. No.: US 2026/0212165 A1
(43) Pub. Date: Jul. 23, 2026

(54) TECHNIQUES FOR CHARACTER MOTION ESTIMATION AND GENERATION USING A MOTION GENERALIST MODEL

(71) Applicant: NVIDIA CORPORATION, Santa Clara, CA (US)

(72) Inventors: Jiefeng LI, Shanghai (CN); Ye YUAN, State College, PA (US); Umar IQBAL, Danville, CA (US); Jinkun CAO, Pittsburgh, PA (US); Haotian ZHANG, Santa Clara, CA (US); Davis Winston REMPE, Redwood City, CA (US); Jan KAUTZ, Lexington, MA (US)

(21) Appl. No.: 19/182,268

(22) Filed: Apr. 17, 2025

Related U.S. Application Data
(60) Provisional application No. 63/748,867, filed on Jan. 23, 2025.

(51) Int. Cl. G06N 3/0475; G06N 3/0455; G06N 3/0985

(52) U.S. Cl. CPC G06N 3/0475; G06N 3/0455; G06N 3/0985

(57) ABSTRACT

One embodiment of a method for training a machine learning model to predict motion includes estimating, using an untrained machine learning model, a first motion based on at least one first condition; generating, using the untrained machine learning model, a second motion based on at least one second condition; computing a loss based on the first motion, the second motion, and one or more ground truth motions; and updating one or more parameters of the untrained machine learning model based on the loss to generate a trained machine learning model.

### CROSS-REFERENCE TO RELATED APPLICATIONS

This application claims priority benefit of the U.S. Provisional Patent Application titled, “TECHNIQUES FOR GENERATING CHARACTER MOTIONS USING A GENERALIST MODEL,” filed on Jan. 23, 2025, and having Ser. No. 63/748,867. The subject matter of this related application is hereby incorporated herein by reference.

### BACKGROUND

### Technical Field

Embodiments of the present disclosure relate generally to robot and virtual character control, artificial intelligence (AI), and machine learning, and, more specifically, to techniques for character motion estimation and generation using a motion generalist model.

### Description of the Related Art

In machine learning, character motion prediction includes both generating motions for characters (also referred to herein as “motion generation”) and estimating the motions of characters (also referred to herein as “motion estimation”) in, for example, a video. Motion generation includes generating realistic movements for a character based on given inputs, such as textual descriptions of the movements, keyframes, and/or the like. Motion generation enables applications such as automated animation of characters, character synthesis in gaming, and virtual avatar control. In robotics, motion generation permits robots and virtual agents to perform complex tasks with natural movements. Motion estimation, on the other hand, includes analyzing observed motion data to infer underlying movement patterns. Motion estimation is useful for tasks such as human pose tracking, motion capture refinement, predictive modeling in autonomous navigation, and/or the like. In applications such as self-driving vehicles, motion estimation can help predict pedestrian behavior, while in augmented and virtual reality applications, motion estimation can improve real-time user interaction by understanding body movements.

One conventional approach for character motion prediction is to treat motion generation and motion estimation as distinct tasks, and different machine learning models can be utilized for the distinct tasks. Motion generation models are commonly trained on large-scale three-dimensional (3D) motion capture datasets and use conditioning inputs, such as text, audio, keyframes, and/or the like, to generate diverse and realistic character motions corresponding to the conditioning inputs. Motion estimation models focus on inferring human motion trajectories from observed signals, such as monocular video, two dimensional (2D) keypoints, depth maps, and/or the like. Conventional approaches for motion generation and motion estimation include optical flow techniques, skeletal pose tracking, and probabilistic models, such as hidden Markov models or Gaussian processes.

One drawback of the above approaches is that different models are required for motion estimation and motion generation. Having to train and execute two different models is computationally expensive and inefficient. The different motion generation and motion estimation models also have their own drawbacks. In that regard, motion generation models can only be trained using large-scale motion capture datasets, meaning that motion generation models cannot be effectively trained in scenarios where limited training data is available or where diverse and novel motion types are desired, but no corresponding motion capture datasets exist for training the motion generation models. On the other hand, motion estimation models often struggle to predict accurate pose estimates when the inputs include occlusions, viewpoint variations, or incomplete observations, especially when the inputs are 2D keypoints or monocular video.

As the foregoing illustrates, what is needed in the art are more effective techniques for character motion prediction.

### SUMMARY

One embodiment of the present disclosure sets forth a computer-implemented method for training a machine learning model to predict motion. The method includes estimating, using an untrained machine learning model, a first motion based on at least one first condition. The method further includes generating, using the untrained machine learning model, a second motion based on at least one second condition. The method also includes computing a loss based on the first motion, the second motion, and one or more ground truth motions. In addition, the method includes updating one or more parameters of the untrained machine learning model based on the loss to generate a trained machine learning model.

Another embodiment of the present disclosure sets forth a computer-implemented method for controlling a character. The method includes receiving one or more conditions. The method further includes, based on the one or more conditions, generating or estimating a motion using a trained machine learning model, where the trained machine learning model is configured to estimate the motion via one denoising diffusion step or generate the motion via a plurality of denoising diffusion steps. In addition, the method includes causing the character to move based on the motion.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques implement a motion generalist model that is capable of performing both motion estimation and motion generation within a unified framework without requiring separate models for motion estimation and motion generation. The estimated and generated motions can be of any length. Motion generation using the generalist model can also be conditioned on multi-modal conditions over various time windows, while transitioning naturally between the conditions. Another technical advantage of the disclosed techniques is that the motion generalist model can be trained using both 3D motion capture datasets and video/2D keypoint datasets. In addition, the disclosed techniques improve motion estimation accuracy by addressing challenges, such as occlusions, viewpoint variations, incomplete observations, and/or the like, by generating pseudo-3D labels. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer-based system configured to implement one or more aspects of the various embodiments;

FIG. 2 is a more detailed illustration of the machine learning server of FIG. 1, according to various embodiments;

FIG. 3 is a more detailed illustration of the model trainer of FIG. 1, according to various embodiments;

FIG. 4 is a more detailed illustration of the computing device of FIG. 1, according to various embodiments;

FIG. 5A is a more detailed illustration of the motion prediction application of FIG. 1 operating in a motion estimation mode, according to various embodiments;

FIG. 5B is a more detailed illustration of the motion prediction application of FIG. 1 operating in a motion generation mode, according to various embodiments;

FIG. 6 is a more detailed illustration of the motion generalist model of FIG. 1, according to various embodiments;

FIG. 7 sets forth a flow diagram of method steps for training a motion generalist model, according to various embodiments;

FIG. 8 sets forth a flow diagram of method steps for estimating motions based on a trained motion generalist model, according to various embodiments;

FIG. 9 sets forth a flow diagram of method steps for generating motions for a character based on a trained motion generalist model, according to various embodiments; and

FIG. 10 is a flow diagram of method steps for generating predicted motions using a trained motion generalist model based on multi-modal conditions and noisy motion, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for character motion estimation and generation using a motion generalist model, which is a machine learning model such as a neural network. In various embodiments, a model trainer trains the motion generalist model based on motion data, which includes multimodal conditions, such as video/2D keypoint conditions, noisy motion, and textual condition. The training begins with the model trainer randomly sampling one or more conditions from motion data. Whenever the model trainer determines the sampled conditions do not include video or 2D keypoints (e.g., skeletal representations of human motion derived from video footage), the motion generalist model uses a motion generation mode to generate motions based on the sampled conditions. Whenever the model trainer determines the sampled conditions includes video/2D keypoints, the motion generalist model performs motion estimation based on the sampled conditions. The model trainer then checks whether the sampled conditions include 3D annotations. Whenever the model trainer determines the sampled conditions include 3D annotations, the motion generalist model uses the motion generation mode to generate motions based on the sampled conditions (e.g., video/2D keypoint conditions with 3D annotations). Whenever the model trainer determines the video/2D keypoint conditions does not include 3D annotations, the motion generalist model generates 3D pseudo-labels, using a motion estimation mode, based on video/2D keypoint conditions. The motion generalist model then uses the motion generation mode to generate motions based on the sampled conditions (e.g., video/2D keypoint conditions with the generated pseudo-3D labels). A loss calculation module then calculates a total loss, which includes at least one of an estimation loss and a 3D diffusion loss based on the predicted motions and ground truth motions. The model trainer then iteratively updates the one or more parameters of the motion generalist model based on the total loss until a predefined stopping criterion is met. Once the motion generalist model is trained, the trained motion generalist model can be used to estimate motions and to generate motions for causing a character to move.

In some embodiments, the trained motion generalist model is used to generate motions to cause a character to move. The motion generalist model processes noisy motion (e.g., motion sequences with added randomness) and multi-modal conditions, which can include video/2D keypoint conditions (e.g., video-based references or keypoint-based observations) and a textual conditions (e.g., text descriptions that specify motion characteristics or intent), and/or the like, and the motion generalist model generates predicted motions. The motion generalist model includes an additive fusion module, one or more Unified Motion Foundation Model (UNiMFM) layers, and a decoder module. Each UNIMFM layer includes a multi-text injection module and a Rotary Positional Encoding-based (RoPE-based) transformer. The additive fusion module processes the multi-modal conditions and noisy motion and generates fused motion embeddings. The multi-text injection module uses a multi-text attention module to process the fused motion embeddings and textual conditions to generate text-conditioned motion embeddings, which integrates the textual conditions into the fused motion embeddings. The ROPE-based transformer processes the text-conditioned motion embeddings and generates refined motion embeddings. The decoder module processes refined motion embeddings and generates the predicted motions which can be used to estimate motions of a character or to generate motions to cause a character to move.

The techniques for character motion prediction have many real-world applications. For example, those techniques could be used to control a physical robot in a real-world environment. As another example, those techniques could be used to control a character in a virtual or extended reality (XR) environment, such as a gaming environment. As a further example, those techniques can be used to control a character in a three-dimensional (3D) animation.

The above examples are not in any way intended to be limiting. As persons skilled in the art will appreciate, as a general matter, the techniques for motion prediction described herein can be implemented in any suitable application.

### System Overview

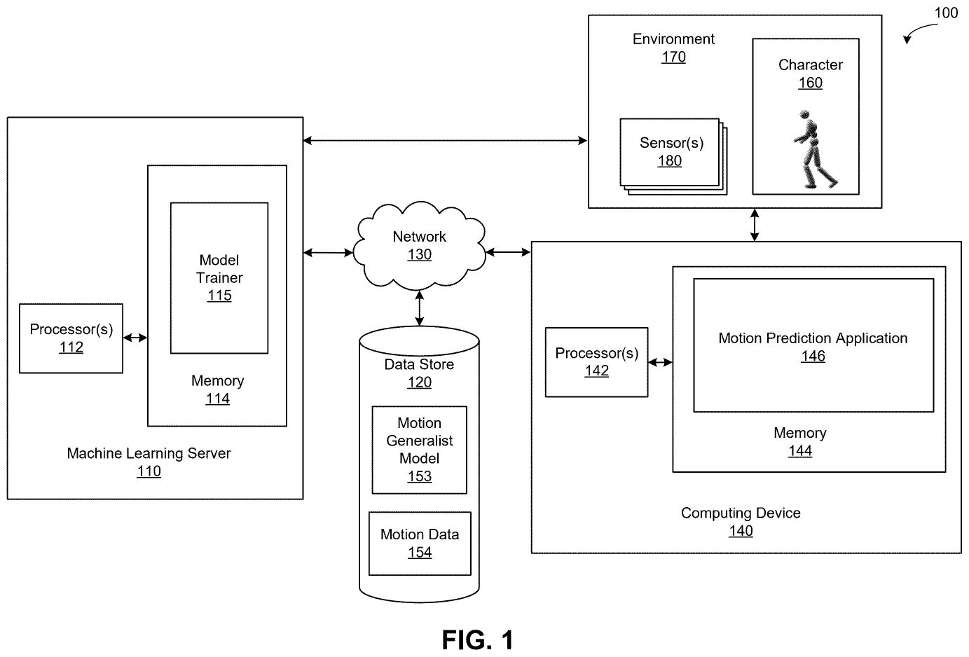

FIG. 1 illustrates a block diagram of a computer-based system 100 configured to implement one or more aspects of at least one embodiment. As shown, system 100 includes, without limitation, a machine learning server 110, a computing device 140, a data store 120, a network 130, and an environment 170. Machine learning server 110 includes, without limitation, one or more processors 112 and memory 114. Memory 114 includes, without limitation, a model trainer 115. Data store 120 includes, without limitation, motion data 154. Computing device 140 includes, without limitation, one or more processors 142 and memory 144. Memory 144 includes, without limitation, a motion prediction application 146. Environment 170 includes, without limitation, a character 160 and one or more sensors 180.

Machine learning server 110 shown herein is for illustrative purposes only, and variations and modifications are possible, without departing from the scope of the present disclosure. For example, the number of processors 112, the number of GPUs and/or other processing unit types, the number of and/or type of memories 114, and/or the number of applications included in the memory 114 can be modified as desired. Further, the connection topology between the various units in FIG. 1 can be modified as desired. In some embodiments, any combination of processor(s) 112, memory 114, and/or GPU(s) can be included in and/or replaced with any type of virtual computing system, distributed computing system, and/or cloud computing environment, such as a public, private, or a hybrid cloud system.

Processor(s) 112 can include any suitable processor(s), such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 112 can be any technically feasible hardware unit capable of processing data and/or executing software applications. During operation, processor(s) 112 receive user input from input devices (not shown), such as a keyboard or a mouse.

Memory 114 of computing device 110 stores content, such as software applications and data, for use by processor(s) 112. As shown, memory 114 includes model trainer 115 and a loss calculation module 151. Memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

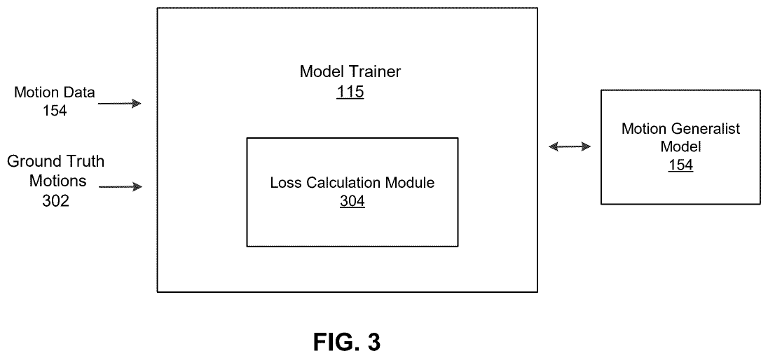

Model trainer 115 is stored in memory 114 and is executed by processor(s) 112. Model trainer 115 is configured to train one or more machine learning models, such as motion generalist model 153, that, once trained, can be used to generate predicted motions to cause a character to move, such as character 160, to perform a task. Model trainer 115 can employ any suitable techniques to train the machine learning model(s). For example, model trainer 115 can use supervised learning, unsupervised learning, reinforcement learning, deep learning, and/or the like to train the machine learning model(s). In some embodiments, model trainer 115 includes a loss calculation module, which processes one or more predicted motions generated by motion generalist model 153 during training and ground truth predictions included in motion data 154 to compute a total loss. In various embodiments, model trainer 153 uses the total loss computed by the loss calculation module to update one or more parameters of motion generalist model 153. Model trainer 115 is discussed in greater detail below in conjunction with FIG. 3.

Data store 120 can include any storage device or devices, such as fixed disc drive(s), flash drive(s), optical storage, network attached storage (NAS), and/or a storage area-network (SAN). Although shown as accessible over network 130, in some embodiments machine learning server 110 can include data store 120. As shown, data store 120 includes motion generalist model 153 and motion data 154.

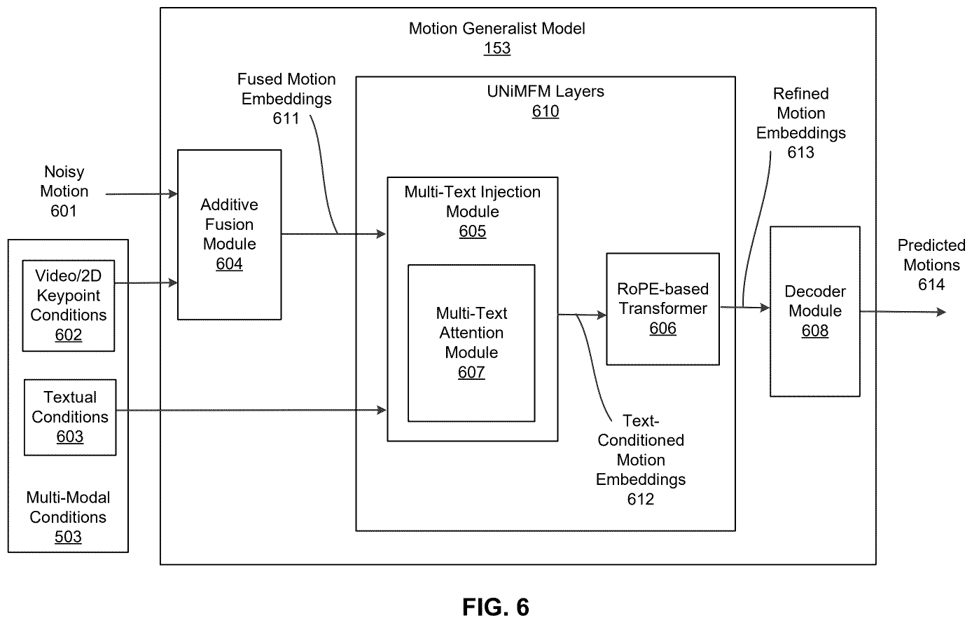

Motion generalist model 153 is a machine learning model that includes a set of parameters that can be optimized by model trainer 115 to assist in the generation of predicted motions for character 160. For example, in some embodiments, motion generalist model 153 can be a neural network. In various embodiments, the parameters of motion generalist model 153 can be learned using backpropagation. In some embodiments, the parameters can be updated as new data becomes available, as the task requirements for character 160 evolve, as a user prompt is received from one or more I/O device(s) (not shown), or the like. Once trained, the trained motion generalist model 153 can be deployed in any suitable manner, such as via motion prediction application 146. Motion generalist model 153 is described in greater detail below in conjunction with FIG. 6.

Motion data 154 is used for training motion generalist model 153. Motion data 154 includes various sets of character motion representations collected from various sources, such as real-world recordings, synthetic simulations, multimodal annotations, and/or the like. In some embodiments, motion data 154 includes observed character motion trajectories, which are recorded from motion capture systems or extracted from video footage, as well as synthetic motion sequences generated through physics-based simulations. Motion data 154 also includes multimodal conditions, such as noisy motions, video/2D keypoint conditions, and, and textual conditions, which provide contextual information for character motion prediction. In some examples, to train motion generalist model 153 for motion generation, motion data 154 can include datasets, such as HumanML3D, which includes character motions from the Archive of Motion Capture as Surface Shapes (AMASS) and HumanAct12 datasets, annotated with textual descriptions. Additionally, motion data 154 can include motion datasets, such as Motion-X that provide 2D keypoints and text descriptions, enabling motion synthesis based on sparse observations. In some examples, to train motion generalist model 153 for motion estimation, motion data 154 can include human motion trajectories from datasets such as AMASS, Body Estimation Dataset with Localization, Anthropometrics, and MoCap (BEDLAM), Human3.6M, and 3D Pose in the Wild (3DPW), which provide pose sequences and skeletal representations extracted from various environments and include a mix of 3D motion sequences, monocular video frames, and structured keypoints, capturing a wide range of human movements. To evaluate predicted motions generated by motion generalist model 153 during training, motion data 154 can include in-the-wild benchmark datasets, such as 3DPW, Real-world In-the-wild Clothing and Human motion dataset (RICH), and Ego-Motion and Dynamic Body (EMDB) dataset.

Network 130 can be a wide area network (WAN), such as the Internet, a local area network (LAN), a cellular network, and/or any other suitable network. Machine learning server 110, computing device 140, and data store 120 are in communication over network 130. For example, network 130 can include any technically feasible network hardware suitable for allowing two or more computing devices to communicate with each other and/or to access distributed or remote data storage devices, such as data store 120.

Computing device 140 shown herein is for illustrative purposes only, and variations and modifications are possible, without departing from the scope of the present disclosure. For example, the number of processors 142, the number of GPUs and/or other processing unit types, the number of memories 144, and/or the number of applications included in the memory 144 can be modified as desired. Further, the connection topology between the various units in FIG. 1 can be modified as desired. In some embodiments, any combination of processor(s) 142, memory 144, and/or GPU(s) can be included in and/or replaced with any type of virtual computing system, distributed computing system, and/or cloud computing environment, such as a public, private, or a hybrid cloud system.

Processor(s) 142 can include any suitable processor(s), such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 142 can be any technically feasible hardware unit capable of processing data and/or executing software applications. During operation, processor(s) 142 receives user input from input devices (not shown), such as a keyboard or a mouse.

Memory 144 of computing device 140 stores content, such as software applications and data, for use by processor(s) 142. As shown, memory 144 includes motion prediction application 146. Memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 144. The storage can include any number and type of external memories that are accessible to processor(s) 142. For example, and without limitation, the storage can include a Secure Digital Card, an external Flash memory, a portable compact disc read-only memory (CD-ROM), an optical storage device, a magnetic storage device, and/or any suitable combination of the foregoing.

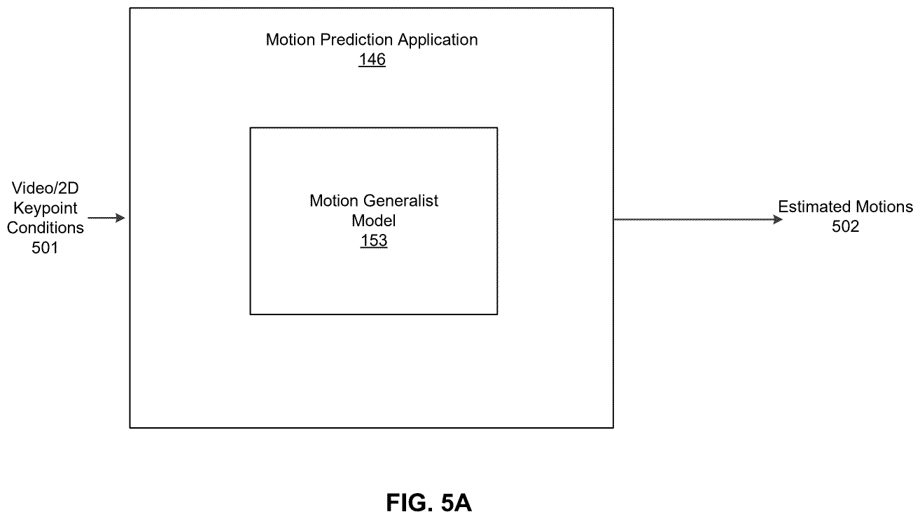

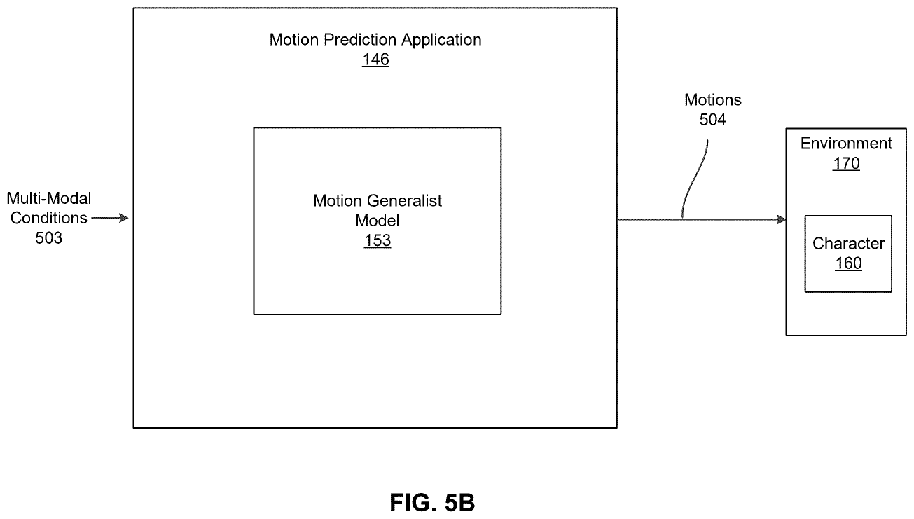

As shown, motion prediction application 146 that uses the trained motion generalist model 153 is stored in memory 144, and executes on processor(s) 142. Motion prediction application 146 is discussed in greater detail below in conjunction with FIGS. 5-6. Illustratively, given sensor data captured by one or more sensors 180 (e.g., force sensors, cameras, and/or the like), motion prediction application 146 uses motion generalist model 153 to estimate motions and generate motions to cause character 160 to move in environment 170.

Environment 170, in which character 160 moves, can be either virtual or physical. In a virtual environment, character 160 can navigate a digitally rendered landscape, such as a simulation of a cityscape with moving traffic and pedestrians, a fantasy world with dynamic terrain and interactive elements, and/or the like. Virtual environments can be used in video game development, virtual reality (VR) applications, advanced AI training simulations, and/or the like. In a physical environment, the movements of character 160, such as a humanoid robot, can include walking, running, jumping, reaching, grasping, bending, and other articulated motions necessary for navigation and interaction with objects or people. Although described herein primarily with respect to human motion as a reference example, in some embodiments, character 160 can include any articulated object, such as a robotic manipulator, a mechanical linkage system, or other forms of articulated objects in virtual or real-world applications. Sensor(s) 180, such as cameras, light detection and ranging (LIDAR), force sensors, and/or the like, gather real-time data to assist character 160 in adapting to the dynamic conditions of environment 170.

In some embodiments, sensor(s) 180 can include vision sensors, such as stereo cameras, LIDAR systems, and/or the like, that enable character 160 to detect objects, assess distances, and/or perceive the operational environment by providing three-dimensional visual data.

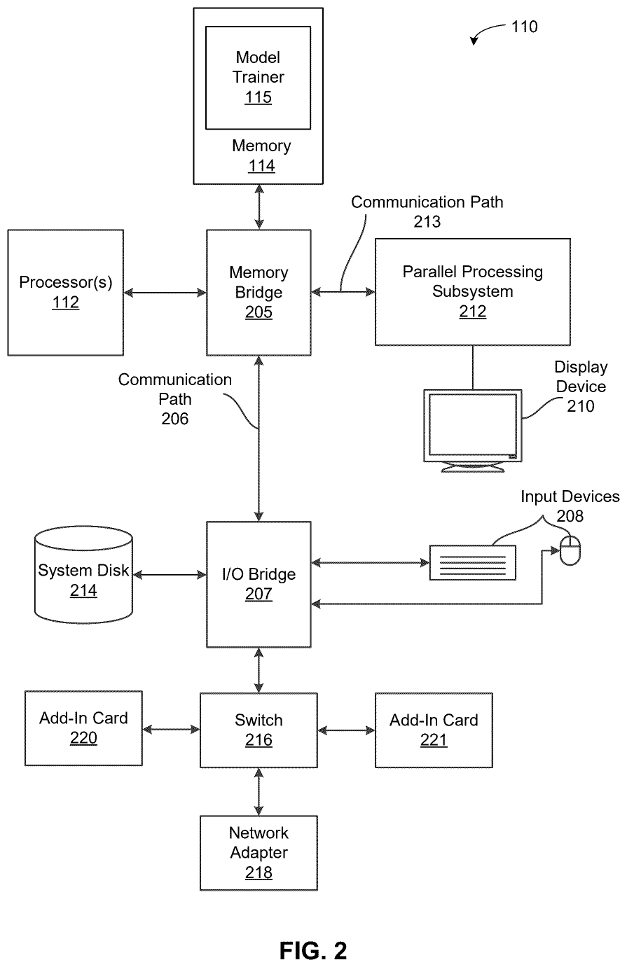

FIG. 2 is a block diagram illustrating machine learning server 110 of FIG. 1 in greater detail, according to various embodiments. Machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In some embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In some embodiments, I/O bridge 207 is configure to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, machine learning server 110 may be a server machine in a cloud computing environment. In such embodiments, machine learning server 110 may not include input devices 208, but can receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add in cards 220 and 221.

In some embodiments, I/O bridge 207 is coupled to a system disk 214 that may be configured to store content and applications and data for use by processor(s) 112 and parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to I/O bridge 207 as well.

In some embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point to point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes model trainer 115. Although described herein primarily with respect to model trainer 115, techniques disclosed herein can also be implemented, either entirely or in part, in other software and/or hardware, such as in parallel processing subsystem 212.

In some embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add in cards 220, 221 would connect directly to I/O bridge 207. Lastly, in certain embodiments, one or more components shown in FIG. 2 may be implemented as virtualized resources in a virtual computing environment, such as a cloud computing environment. In particular, parallel processing subsystem 212 may be implemented as a virtualized parallel processing subsystem in some embodiments. For example, parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training a Motion Generalist Model

FIG. 3 is a more detailed illustration of model trainer 115 of FIG. 1, according to various embodiments. As shown, model trainer 115 includes, without limitation, a loss calculation module 304. In operation, model trainer 115 uses motion data 154 and ground truth motions 302 to train motion generalist model 153.

In various embodiments, the gravity-view coordinate system is followed to represent the global trajectory of the character 160 at an i^{th} frame as the gravity-view orientation

$${Γ}_{g v}^{i} ∈ {ℝ}^{6}$$

and the local root velocities

$${v}_{root}^{i} ∈ {ℝ}^{3} .$$

The local motion at the i^{th} frame is represented as the skinned multi-person linear (SMPL) parameters, with the joint angles θⁱ∈ [symbol] ^{4×6}, shape parameters βⁱ∈ [symbol] ¹⁰, and the root translation

$${t}_{r o o t}^{i} ∈ {ℝ}^{3} .$$

The camera pose at the i^{th} frame is represented as the camera-to-world transformation

$${π}^{i} = ( {Γ}_{cv}^{i} , {t}_{c v}^{i} ) ,$$

including the camera-view orientation

$${Γ}_{c v}^{i} ∈ {ℝ}^{6}$$

and the camera translation.

$${t}_{c v}^{i} ∈ {ℝ}^{3} .$$

Additionally, contact labels pⁱ ∈ [symbol] ⁶ for hands and feet are included. The generated motion sequence

$${x}^{1 : N} = {\{ {x}^{i} \}}_{i = 1}^{N}$$

is a sequence of N 3D character poses, where each pose xⁱ ∈ [symbol] ^{D} is represented as the combination of the global motion, local motion, and camera poses

$${x}^{i} = ( {Γ}_{gv}^{i} , {v}_{root}^{i} , {θ}^{i} , {β}^{i} , {t}_{root}^{i} , {π}^{i} , {p}^{i} ) .$$

During training, model trainer 115 randomly samples one or more conditions from motion data 154. In various embodiments, motion data 154 includes various multi-modal conditions C={Cₜₑₓₜ, C_{video}, C_{2D}, C_{3D}, C_{speech}, C_{audio}}, where Cₜₑₓₜ includes textual conditions (e.g., “a person jumping”), C_{video} includes of video conditions, C_{2D} includes 2D keypoint conditions extracted from video (e.g., skeleton representations), C_{3D} includes 3D conditions, such as motion capture data (e.g., SMPL parameters), C_{speech} and C_{audio} include spoken instruction and background audio conditions (e.g., music). Each condition applies to a corresponding time window, which can be the entire duration of a motion or a portion thereof. In some embodiments, model trainer 115 randomly samples a condition C_{sampled} ⊆C from motion data 154. Whenever model trainer 115 determines the sampled conditions C_{sampled} does not include video conditions C_{video} or 2D keypoint conditions C_{2D}, motion generalist model 153 uses a motion generation mode to generate motions based on the sampled conditions. In some embodiments, model trainer 115 performs a forward and reverse diffusion process to train motion generalist model 153. In some embodiments, to permit motion generalist model 153 to learn to reconstruct ground truth clean motions

$${x}_{0}^{1 : N} ,$$

Gaussian noise is iteratively added to the clean motion sequence, following a Markov chain process

$$q ( {x}_{t}^{1 : N} \vert {x}_{t - 1}^{1 : N} ) = 𝒩 ( \sqrt{{α}_{t}} {x}_{t - 1}^{1 : N} , ( 1 - {α}_{t} ) I ) , \qquad ( Equation 1 )$$

where

$${x}_{t}^{1 : N}$$

is the noisy motion at timestep t, αₜ ∈(0,1) is the variance schedule controlling the noise injection, and I is the identity matrix. In some examples, in order to permit convergence of the training, model trainer 115 sets αₜ close to zero as t becomes large. At the final denoising timestep T, the motion becomes complete Gaussian noise:

$${x}_{T}^{1 : N} ∼ 𝒩 ( 0 , I ) . \qquad ( Equation 2 )$$

Then, model trainer 115 performs a reverse diffusion process (e.g., motion denoising) to train motion generalist model 153. In some embodiments, motion generalist model 153 learns to denoise x_{T} to recover x₀, given sampled conditions:

$${\hat{x}}_{0} = {M}_{θ} ( {x}_{t} , t , {C}_{sampled} ) , \qquad ( Equation 3 )$$

where M_{θ}(xₜ, t, C) represents motion generalist model 153 parameterized by one or more parameters θ and xₜ is the noisy motion at time t. For example, M_{θ} can be a transformer model. Whenever model trainer 115 determines the sampled conditions C_{sampled} include video conditions C_{video} or 2D keypoint conditions C_{2D}, motion generalist model 153 performs motion estimation based on the sampled conditions. In some embodiments, model trainer 115 performs a one-step diffusion to estimate motions. In some examples, motion generalist model 153 estimates the clean motion x₀ given video conditions or 2D keypoint conditions as described below:

$${\hat{x}}_{0} = {M}_{θ} ( {x}_{T} , T , {C}_{video} , {C}_{2 D} ) . \qquad ( Equation 4 )$$

Model trainer 115 then checks whether the sampled conditions include 3D annotations. Whenever the model trainer determines the sampled conditions include 3D annotations C_{3D}, motion generalist model 153 uses the motion generation mode to generate motions based on the sampled conditions, for example, as described by Equations 1-3. Whenever model trainer 115 determines the sampled conditions does not include 3D annotations C_{3D}, motion generalist model 153 generates 3D pseudo-labels, using a motion estimation mode, based on the sampled conditions. In some embodiments, motion generalist model 153 generates estimated motion \hat{x}ₜ as a pseudo-3D label:

$${\hat{x}}_{t} = {M}_{θ} ( z , T , {C}_{video} , {C}_{2 D} ) . \qquad ( Equation 5 )$$

where z~ [symbol] (0, I) is a Gaussian noise. Motion generalist model 153 then uses the motion generation mode to generate motions based on conditions (e.g., video/2D keypoint conditions with the generated pseudo-3D labels), for example, as described by Equations 1-3 with Equation 1 starting with \hat{x}ₜ as given in Equation 5.

Loss calculation module 304 then calculates a total loss, which includes at least one of an estimation loss and a 3D diffusion loss based on the predicted motions and ground truth motions 302. In some embodiments, loss calculation module 304 calculates a geometric loss to permit physically plausible motion. In some examples, loss calculation module 304 calculates the geometric loss as described below:

$${ℒ}_{g e o} = {L}_{vert - global} + {L}_{vert - local} + {L}_{j oint - global} + {L}_{j oint - local} + {L}_{c o n t a c t} , \qquad ( Equation 6 )$$

where, L_{vert-global} is the loss for global vertex position consistency, L_{vert-local:} is the loss for local vertex movement regularization, L_{joint-global} is the loss for global joint position stability, L_{joint-local} is the loss for limb articulation accuracy, and L_{contact:} is the loss for foot-ground and hand-surface contact enforcement. The loss in Equation 6 permits that the generated motion adheres to real-world physics and avoids floating or unnatural artifacts. In some embodiments, loss calculation module 304 calculates the estimation loss for the motion estimation mode based on the estimated motions. In some examples, loss calculation module 304 calculates the estimation loss as:

$${ℒ}_{est} = {𝔼}_{{x}_{0} ∼ q ( {x}_{0} ) \vert C , t = T} [ {‖ {x}_{0} - {M}_{θ} ( {x}_{t} , t , {C}_{video} , {C}_{2 D} ) ‖}^{2} ] . \qquad ( Equation 7 )$$

Whenever video conditions or 2D keypoint conditions are available, loss calculation module 304 generates a 2D projection loss. In some examples, the 2D projection loss is calculated as

$${ℒ}_{g e n - 2 D} = {𝔼}_{{x}_{0} ∼ q ( {x}_{0} ) \vert C , t ∼ [ 1 , T ]} [ {‖ Π ( {x}_{0} ) - Π ( {M}_{θ} ( {x}_{t} , t , C ) ) ‖}^{2} ] , \qquad ( Equation 9 )$$

where Π is a 2D re-projection function. Whenever 3D annotations are available in sampled conditions, loss calculation module 154 generates a 3D diffusion loss. In some examples, loss calculation module 154 generates the 3D diffusion loss as:

$${ℒ}_{g e n - 3 D} = {𝔼}_{{x}_{0} ∼ q ( {x}_{0} \vert C ) , t ∼ [ 1 , T ]} [ {‖ {x}_{0} - {M}_{θ} ( {\hat{x}}_{t} , t , C ) ‖}^{2} ] . \qquad ( Equation 10 )$$

In some embodiments, loss calculation module 304 calculates the total loss based at least the 3D diffusion loss or the estimation loss. In some examples, loss calculation module 304 calculates total loss as described below:

$${ℒ}_{total} = {ℒ}_{est} + {ℒ}_{g e n - 3 D} + {ℒ}_{g e n - 2 D} + {ℒ}_{g e o} . \qquad ( Equation 11 )$$

Model trainer 115 then iteratively updates the one or more parameters of motion generalist model 153 based on the total loss until a predefined stopping criterion is met. In some examples, model trainer 115 updates the one or more parameters of motion generalist model 153 using gradient descent:

$$θ ← θ - η {∇}_{θ} {ℒ}_{total} , \qquad ( Equation 12 )$$

where η∈(0,1) is the learning rate. In various embodiments, model trainer 115 uses a stopping criterion permitting motion generalist model 153 to reach acceptable performance without overfitting or underfitting. In some embodiments, model trainer 115 monitors the total loss function [symbol] ₜₒₜₐₗ over validation data and stops training when the total loss stops decreasing for a certain number of epochs, known as early stopping. In some examples, training stops when:

$$\frac{1}{L} {\sum }_{i = 1}^{L} {ℒ}_{total}^{( i )} - {ℒ}_{total}^{( i - 1 )} < ε , \qquad ( Equation 13 )$$

where L is the number of recent epochs, and ε is a small threshold that determines whether the improvement in total loss is significant. In some embodiments, model trainer 115 uses a stopping criterion which includes tracking motion quality metrics, such as mean per joint position error (MP JPE), Frechet distance between generated and real motion distributions, and/or the like, and stopping when the metrics plateau. In some embodiments, model trainer 115 stops training motion generalist model 153 after a fixed number of iterations.

### Motion Estimation and Generation Using a Trained Generalist Model

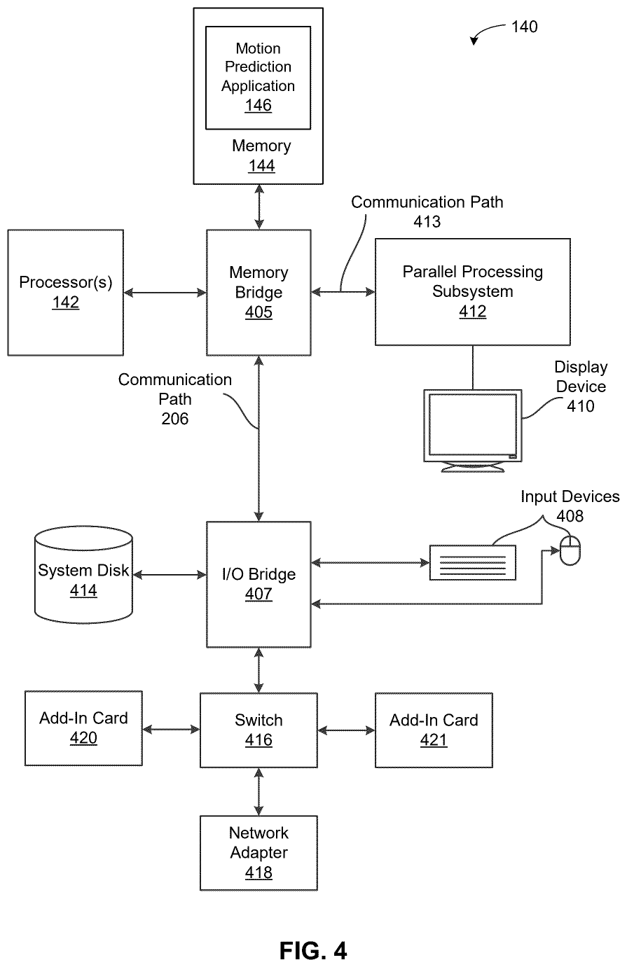

FIG. 4 is a block diagram illustrating computing device 140 of FIG. 1 in greater detail, according to various embodiments. Computing device 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In some embodiments, computing device 140 includes, without limitation, processor(s) 142 and memory(ies) 144 coupled to a parallel processing subsystem 412 via a memory bridge 405 and a communication path 413. Memory bridge 405 is further coupled to an I/O (input/output) bridge 407 via a communication path 406, and I/O bridge 407 is, in turn, coupled to a switch 416.

In some embodiments, I/O bridge 407 is configured to receive user input information from optional input devices 408, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 can be a server machine in a cloud computing environment. In such embodiments, computing device 140 can not include input devices 408, but can receive equivalent input information by receiving commands (e.g., responsive to one or more inputs from a remote computing device) in the form of messages transmitted over a network and received via network adapter 418. In some embodiments, switch 416 is configured to provide connections between I/O bridge 407 and other components of machine learning server 110, such as a network adapter 418 and various add in cards 420 and 421.

In some embodiments, I/O bridge 407 is coupled to a system disk 414 that can be configured to store content and applications and data for use by processor(s) 142 and parallel processing subsystem 412. In some embodiments, system disk 414 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, can be connected to I/O bridge 407 as well.

In some embodiments, memory bridge 405 may be a Northbridge chip, and I/O bridge 407 can be a Southbridge chip. In addition, communication paths 406 and 413, as well as other communication paths within computing device 140, can be implemented using any technically suitable protocols, including, without limitation, AGP (Accelerated Graphics Port), HyperTransport, or any other bus or point to point communication protocol known in the art.

In some embodiments, parallel processing subsystem 412 comprises a graphics subsystem that delivers pixels to an optional display device 210 that may be any conventional cathode ray tube, liquid crystal display, light-emitting diode display, and/or the like. In such embodiments, parallel processing subsystem 412 can incorporate circuitry optimized for graphics and video processing, including, for example, video output circuitry. Such circuitry may be incorporated across one or more parallel processing units (PPUs), also referred to herein as parallel processors, included within parallel processing subsystem 412.

In some embodiments, parallel processing subsystem 412 incorporates circuitry optimized (e.g., that undergoes optimization) for general purpose and/or compute processing. Again, such circuitry may be incorporated across one or more PPUs included within parallel processing subsystem 412 that are configured to perform such general purpose and/or compute operations. In yet other embodiments, the one or more PPUs included within parallel processing subsystem 412 can be configured to perform graphics processing, general purpose processing, and/or compute processing operations. System memory 144 includes at least one device driver configured to manage the processing operations of the one or more PPUs within parallel processing subsystem 412. In addition, system memory 144 includes motion prediction application 146. Although described herein primarily with respect to motion prediction application 146, techniques disclosed herein can also be implemented, either entirely or in part, in other software and/or hardware, such as in parallel processing subsystem 412.

In some embodiments, parallel processing subsystem 412 can be integrated with one or more of the other elements of FIG. 2 to form a single system. For example, parallel processing subsystem 412 can be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issues commands that control the operation of PPUs. In some embodiments, communication path 412 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 412, can be modified as desired. For example, in some embodiments, system memory 144 could be connected to processor(s) 142 directly rather than through memory bridge 405, and other devices can communicate with system memory 144 via memory bridge 405 and processor 142. In other embodiments, parallel processing subsystem 412 can be connected to I/O bridge 407 or directly to processor 142, rather than to memory bridge 405. In still other embodiments, I/O bridge 407 and memory bridge 405 can be integrated into a single chip instead of existing as one or more discrete devices. In certain embodiments, one or more components shown in FIG. 2 may not be present. For example, switch 416 could be eliminated, and network adapter 418 and add in cards 420, 421 would connect directly to I/O bridge 407. Lastly, in certain embodiments, one or more components shown in FIG. 2 may be implemented as virtualized resources in a virtual computing environment, such as a cloud computing environment. In particular, parallel processing subsystem 412 can be implemented as a virtualized parallel processing subsystem in some embodiments. For example, parallel processing subsystem 412 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 5A is a more detailed illustration of motion prediction application 146 of FIG. 1 operating in the motion estimation mode, according to various embodiments. As shown, motion prediction application 146 includes, without limitation, the trained motion generalist model 153. Motion prediction application 146 processes one or more video/2D keypoint conditions 501 and generates estimated motions 502.

In various embodiments, motion prediction application 146 uses the trained motion generalist model 153 to generate estimated motions 502 by performing a single-step denoising diffusion. To begin the estimation process, the trained motion generalist model 153 starts with a randomly sampled noisy motion representation. In some examples, the sampled noisy motion is modeled as a Gaussian-distributed random variable x_{T}~ [symbol] (0, I), where x_{T} represents a fully noisy motion sequence at the highest timestep T, and I is the identity matrix. In some embodiments, the trained motion generalist model 153 directly predicts the clean motion in a single denoising diffusion step. In some examples, given the video/2D keypoint conditions 501 C_{video}, C_{2D}, the trained motion generalist model 153 applies a single reverse diffusion step to predict the clean motion sequence x₀:

$${\hat{x}}_{0} = {M}_{θ} ( {x}_{T} , T , {C}_{video} , {C}_{2 D} ) . \qquad ( Equation 14 )$$

Equation 14 is equivalent to removing the noise in one iteration to generate estimated motions 502. Estimated motions 502 can be represented over a horizon N as:

$${\hat{x}}_{0} = \{ {\hat{x}}_{0}^{( 1 )} , {\hat{x}}_{0}^{( 2 )} , … , {\hat{x}}_{0}^{( N )} \} , \qquad ( Equation 15 )$$

where

$${\hat{x}}_{0}^{( i )}$$

are the estimated pose of the character 160 at frame i. Estimated motions 502 can be used for applications such as character animation, motion analysis, robotic imitation of human movements, and/or the like.

FIG. 5B is a more detailed illustration of motion prediction application 146 of FIG. 1 operating in the motion generation mode, according to various embodiments. As shown, motion prediction application 146 uses the trained motion generalist model 153 to process multi-modal conditions 503 and generate motions 504 to cause character 160 to move in environment 170. Multi-modal conditions 503 can include one or more conditions specified in any technically feasible modality or modalities, such as one or more textual conditions (e.g., “a person jumping”), video conditions, 2D keypoint conditions extracted from video (e.g., skeleton representations), 3D conditions (e.g., motion capture data (e.g., SMPL parameters)), spoken instruction and background audio conditions (e.g., music), and/or the like. As another example, multi-modal conditions 503 could specify other object(s), such as the motion of another character, that character 160 should interact with. Each condition in multi-modal conditions 503 applies to a corresponding time window, which can be the entire duration of a motion or a portion thereof. For example, a user could specify various conditions that apply to different time windows on a timeline.

In some embodiments, motion prediction application 146 uses the trained motion generalist model 153 to generate motions 504. In various embodiments, motion prediction application 146 uses the trained motion generalist model 153 to generate predicted motions by performing multiple denoising diffusion steps (e.g., 50 steps). The motion generation follows a multi-step diffusion-based process to progressively refine the motion from an initial noisy state. The process starts by sampling a motion sequence from a Gaussian distribution x_{T}~ [symbol] (0, I), where x_{T} represents a fully noisy motion sequence at the highest timestep T, and I is the identity matrix. Motion prediction application 146 then iteratively applies a trained denoising function, namely motion generalist model 153, to gradually reconstruct the motion. At each timestep t, the motion is refined by predicting the clean motion sequence x₀ and adding a smaller amount of noise to the clean motion sequence x₀ in order to update xₜ to xₜ₋₁. In some examples, the reverse diffusion process follows:

$${x}_{t - 1} = {M}_{θ} ( {x}_{t} , t , C ) + {ϵ}_{t} , \qquad ( Equation 16 )$$

where M_{θ}(xₜ, t, C) is the trained motion generalist model 153 predicting the clean motion at timestep t, C represents multi-modal conditions 503, and ∈ₜ~ [symbol] (0,I) is the noise added at each step to prevent overfitting. The process continues iteratively, denoising the motion step by step until reaching timestep t=0, where the final motion sequence is obtained \hat{x}₀=M(x₁, 1, C) and

$${\hat{x}}_{0} = \{ {\hat{x}}_{0}^{( 1 )} , {\hat{x}}_{0}^{( 2 )} , … , {\hat{x}}_{0}^{( N )} \} ,$$

are the predicted motions. In some embodiments, motion prediction application 146 uses various trajectory generation or control algorithms, such as model predictive control and/or the like, to process the predicted motions generated via the multiple denoising diffusion steps and generate motions 504. For example, the predicted motions via the multiple denoising diffusion steps could be motion primitives, and the generated motions 504 could be actual joint torques etc. Then motion predict application 146 causes character 160 to move based on the generated motions 504. For example, in some embodiments, motion prediction application 146 can transmit the generated motions 504 to a low-level controller (e.g., a proportional integral derivative (PID) controller, a proportional derivative (PD) controller, etc.) of joint actuators of a physical or simulated robot. As another example, in some embodiments, motion prediction application 146 can update the joint positions of a virtual character within a virtual environment based on the generated motions 504.

FIG. 6 is a more detailed illustration of the motion generalist model 153 of FIG. 1, according to various embodiments. As shown, motion generalist model 153 processes noisy motion 601 and multi-modal conditions 503 and generates predicted motions 614. Multi-modal conditions 503 include, without limitation, video/2D keypoint conditions 602 and/or textual conditions 603. Motion generalist model 153 includes, without limitation, an additive fusion module 604, one or more UNiMFM layers 610, and a decoder module 608. One or more UNIMFM layers 610 include, without limitation, multi-text injection module 605 and RoPE-based transformer 606. Multi-text injection module 605 includes, without limitation, multi-text attention module 607. In operation, additive fusion module 604 processes noisy motion 601 and video/2D keypoint conditions 602 and generates fused motion embeddings 611. Multi-text injection module 605 uses multi-text attention module 607 to process fused motion embeddings 611 and textual conditions 603 and generate text-conditioned motion embeddings 612. RoPE-based transformer 606 processes text-conditioned motion embeddings 612 and generates refined motion embeddings 613. Decoder module 608 processes refined motion embeddings 613 to generate predicted motions 614.

As described, additive fusion module 604 processes noisy motion 601 and video/2D keypoint conditions 602 and generates fused motion embeddings 611. In some embodiments, additive fusion module 604 includes multilayer perceptrons to process video/2D keypoint conditions 602 and generate per-frame motion tokens. Additive fusion module 604 also includes a linear layer to fuse the noisy motion 601 xₜ with per-frame motion tokens to generate fused motion embeddings 611. In some embodiments, in motion estimation mode, noisy motion 601 includes x_{T} during the single-step denoising diffusion. In some embodiments, in motion generation mode, noisy motion 601 includes any of the xₜ, t=1, . . . , T during the multi-step diffusion.

One or more UniMFM layers 610 processes fused motion embeddings 611 and textual conditions 603 and generates refined motion embeddings 613. As shown, UniMFM layers 610 (e.g., 16 UniMFM layers) include, without limitation, multi-text injection module 605 and RoPE-based transformer 606. Multi-text injection module 605 uses multi-text attention module 607 to process fused motion embeddings 611 and textual conditions 603 to generate text-conditioned motion embeddings 612. In some embodiments, multi-text injection module 605 processes one or more user inputs (not shown) to specify which textual condition 603 corresponds to which segment of the motion sequence included in video/2D keypoint conditions 602. In some embodiments, multi-text attention module 607 first processes textual conditions 603 by encoding textual conditions 603 into text embeddings τ₁, τ₂, . . . , τ_{K}, where each τₖ represents the embedding of a textual condition 603. The text embeddings are then used as the keys in a masked multi-head attention operation that conditions the motion feature sequence fᵢₙ included in fused motion embeddings 611. In some embodiments, multi-text attention module 607 applies masked multi-head attention over the motion sequence, permitting that each textual condition 603 influences only the corresponding time window within the motion sequence. In some examples, the masked muti-head attention is performed using a binary mask [symbol] (i, j), which determines whether the textual condition 603 τₖ affects a given motion feature sequence fᵢₙ (i). For example, the text-conditioned motion embeddings 612 can be computed as:

$${f}_{o u t} = {\sum }_{k = 1}^{K} MaskedMHA ( {f}_{in} , {τ}_{k} , {ℳ}_{k} ) , \qquad ( Equation 17 )$$

where MaskedMHA represents the masked multi-head attention operation and the masking function [symbol] ₖ(i, j) is defined as:

$${ℳ}_{k} ( i , j ) = \{ \begin{matrix}1 , & if i is inside time window of textual condition k \\ 2 , & otherwise\end{matrix} . \qquad ( Equation 18 )$$

The final output (e.g., text-conditioned motion embeddings 612), fₒᵤₜ, includes motion features that are conditioned on the provided textual conditions 603.

RoPE-based transformer 606 processes text-conditioned motion embeddings 612 and generates refined motion embeddings 613. In some embodiments, RoPE-based transformer 606 uses RoPE, which encodes relative temporal positions instead of absolute positions, permitting that motion sequences of varying lengths can be processed. Unlike traditional positional encodings, which rely on fixed length sequences, ROPE permits the processing of longer or shorter motion sequences without modifying the learned representation. In various embodiments, RoPE-based transformer 606 uses self-attention mechanisms to process text-conditioned motion embeddings 611 while maintaining the temporal relationships. In some embodiments, RoPE-based transformer 606 computes attention scores based on relative positional relationships to capture the motion dependencies across time while remaining fully compatible with image-conditioned motion generation, such as video-based motion generation.

Decoder module 608 processes refined motion embeddings 613 and generates predicted motions 614. In various embodiments, decoder module 608 includes a transformer that reconstructs the predicted motions 614 from the refined motion embeddings 613. In some embodiments, predicted motion 614 includes a sequence of poses over time, such as 3D joint positions.

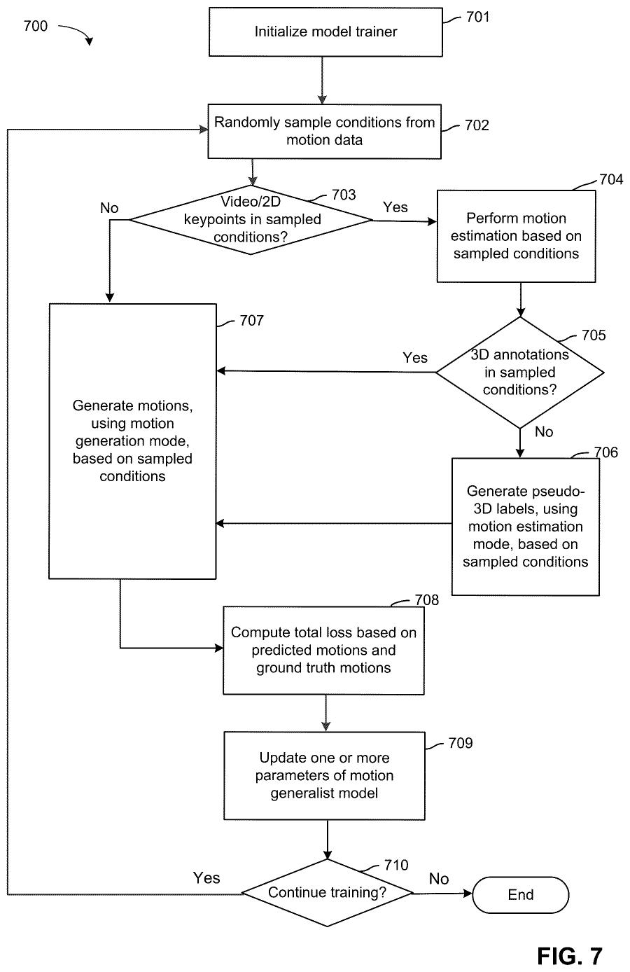

FIG. 7 sets forth a flow diagram of method steps for training a motion generalist model 153, according to various embodiments. Although the method steps are described in conjunction with the systems of FIGS. 1-6, persons skilled in the art will understand that any system configured to perform the method steps in any order falls within the scope of the present disclosure.

As shown, a method 700 begins with step 701, wherein model trainer 115 is initialized. In various embodiments, model trainer 115 initializes the values of the one or more parameters of motion generalist model 153 randomly. In some embodiments, model trainer 115 initializes one or more hyperparameters used during the training. For example, the learning rate as described in Equation 12 could be initialized. In some embodiments, model trainer 115 initializes the maximum number of training epochs and parameters L and ε as defined in Equation 13. In some embodiments, model trainer 115 initializes the diffusion-based denoising process by defining the noise schedule, such as cosine noise scheduler, and parameter αₜ that governs how noise is added and removed during training.

At step 702, model trainer 115 randomly samples conditions from motion data 154. In various embodiments, motion data 154 includes various multi-modal conditions 502, such video/2D conditions 602, as described above in conjunction with FIG. 3.

At step 703, model trainer 115 checks whether video/2D keypoints are included in sampled conditions. Whenever model trainer 115 determines that video/2D keypoints are included in sampled conditions, method 700 proceeds to step 704. Whenever model trainer 115 determines that video/2D keypoints are not included in sampled conditions, method 700 proceeds to step 707.

At step 704, model trainer 115 performs motion estimation based on sampled conditions. In some examples, motion generalist model 153 estimates the clean motion given video/2D keypoint conditions 602 as described by Equation 4.

At step 705, model trainer 115 checks whether 3D annotations are included in sampled conditions. Whenever model trainer 115 determines that 3D annotations are included in sampled conditions, the method 700 proceeds to step 707. Whenever model trainer 115 determines that 3D annotations are not included in sampled conditions, the method 700 proceeds to step 706.

At step 706, motion generalist model 153 generates pseudo-3D labels, using motion estimation mode, based on sampled conditions. In some embodiments, motion generalist model 153 generates estimated motion as a pseudo-3D label as described in Equation 5.

At step 707, motion generalist model 153 generates motions, using motion generation mode, based on sampled conditions. In some embodiments, to permit motion generalist model 153 to learn to reconstruct ground truth clean motions Gaussian noise is iteratively added to the clean motion sequence, following a Markov chain process as described by Equation 1. At the final denoising timestep, the motion becomes complete Gaussian noise as described by Equation 2. Then, model trainer 115 performs a reverse diffusion process (e.g., motion denoising) to train motion generalist model 153. In some embodiments, motion generalist model 153 learns to denoise the motion at the final time step to recover the motion at time zero, given sampled conditions as described by Equation 3. In some embodiments, whenever 3D annotation are included in sampled conditions, motion generalist model 153 uses the motion generation mode to generate motions based on conditions (e.g., video/2D keypoint conditions with the generated pseudo-3D labels), for example, as described by Equations 1-3 with Equation 1 starting with \hat{x}ₜ as given in Equation 5.

At step 708, loss calculation module 304 computes a total loss based on predicted motions 614 and ground truth motions 302. In some embodiments, loss calculation module 304 calculates a geometric loss to permit physically plausible motion. In some examples, loss calculation module 304 calculates the geometric loss as described by Equation 6. In some embodiments, loss calculation module 304 calculates the estimation loss for the motion estimation mode based on the estimated motions. In some examples, loss calculation module 304 calculates the estimation loss as described by Equation 7. Whenever video/2D keypoint conditions 602 are available, loss calculation module 304 generates a 2D projection loss. In some examples, the 2D projection loss is calculated as described by Equation 9. Whenever 3D annotations are available in sampled conditions, loss calculation module 154 generates a 3D diffusion loss. In some examples, loss calculation module 154 generates the 3D diffusion loss as described by Equation 10. In some embodiments, loss calculation module 304 calculates the total loss based on at least the 3D diffusion loss or the estimation loss. In some examples, loss calculation module 304 calculates the total loss as described by Equation 11.

At step 709, model trainer 115 updates one or more parameters of motion generalist model 153. In some examples, model trainer 115 updates the one or more parameters of the motion generalist model 153 using gradient descent as described by Equation 12.

At step 710, model trainer 115 checks whether to continue training. In various embodiments, model trainer 115 uses a stopping criterion permitting motion generalist model 153 to reach acceptable performance without overfitting or underfitting. In some embodiments, model trainer 115 monitors the total loss function over validation data and stops training when the total loss stops decreasing for a certain number of epochs, such as described in Equation 13. In some embodiments, model trainer 115 uses a stopping criterion which includes tracking motion quality metrics, such as MPJPE, Frechet distance between generated and real motion distributions, and/or the like, and stops when the metrics plateau. In some embodiments, model trainer 115 stops training motion generalist model 153 after a fixed number of iterations. Whenever model trainer 115 determines to continue training, the method 700 returns to step 702 to randomly sample new conditions from motion data 154. Whenever model trainer 115 determines not to continue training, method 700 terminates and model trainer 115 stores the trained motion generalist model 153 in data store 120 or elsewhere.

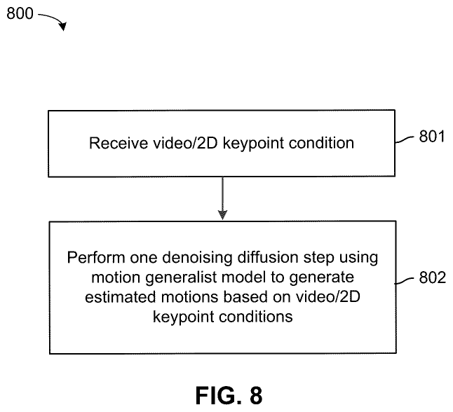

FIG. 8 sets forth a flow diagram of method steps for generating estimated motions 502 based on a trained motion generalist model 153, according to various embodiments. Although the method steps are described in conjunction with the systems of FIGS. 1-6, persons skilled in the art will understand that any system configured to perform the method steps in any order falls within the scope of the present disclosure.

As shown, a method 800 begins with step 801, wherein model prediction application 146 receives video/2D keypoint conditions 501. In some embodiments, model prediction application 146 receives video/2D keypoint conditions 501 from one or more I/O devices.

At step 802, motion prediction application 146 performs one denoising diffusion step using motion generalist model 153 to generate estimated motions 501 based on video/2D keypoint conditions 501. To begin the estimation process, the trained motion generalist model 153 starts with a randomly sampled noisy motion representation. In some examples, the sampled noisy motion is modeled as a Gaussian-distributed random variable x_{T}~ [symbol] (0, I). In some embodiments, the trained motion generalist model 153 directly predicts the clean motion in a single denoising diffusion step. In some examples, given the video/2D keypoint conditions 501 C_{video}, C_{2D}, the trained motion generalist model 153 applies a single reverse diffusion step to predict the clean motion sequence x₀ as described in Equation 14.

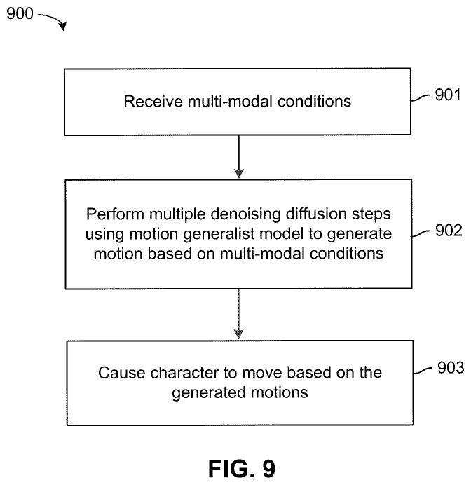

FIG. 9 sets forth a flow diagram of method steps for generating motions 504 for a character 160 based on the trained motion generalist model 153, according to various embodiments. Although the method steps are described in conjunction with the systems of FIGS. 1-6, persons skilled in the art will understand that any system configured to perform the method steps in any order falls within the scope of the present disclosure.

As shown, a method 900 begins with step 901, where motion prediction application 146 receives multi-modal conditions 503. In various embodiments, motion prediction application 146 receives multi-modal conditions 503 from one or more I/O devices. As described, multi-modal conditions 503 can include one or more conditions specified in any technically feasible modality or modalities, such as one or more textual conditions (e.g., “a person jumping”), video conditions, 2D keypoint conditions extracted from video (e.g., skeleton representations), 3D conditions (e.g., motion capture data (e.g., SMPL parameters)), spoken instruction and background audio conditions (e.g., music), and/or the like. As another example, multi-modal conditions 503 could specify other object(s), such as the motion of another character, that character 160 should interact with. Each condition in multi-modal conditions 503 applies to a corresponding time window, which can be the entire duration of a motion or a portion thereof. For example, a user could specify various conditions that apply to different time windows on a timeline.

At step 902, motion prediction application 146 performs multiple denoising diffusion steps using motion generalist model 153 to predict a motion, which is a generated motion, based on multi-modal conditions 503. In some embodiments, the motion generation follows a multi-step diffusion-based process to progressively refine the motion from an initial noisy state. The process starts by sampling a motion sequence from a Gaussian distribution x_{T}~ [symbol] (0, I), where x_{T} represents a fully noisy motion sequence at the highest timestep T, and I is the identity matrix. Motion generalist model 153 then iteratively applies a trained denoising function to gradually reconstruct the motion. At each timestep t, the motion is refined by predicting the clean motion sequence x₀ and adding a smaller amount of noise to the clean motion sequence x₀ in order to update xₜ to xₜ₋₁. In some examples, the reverse diffusion process follows Equation 16. The process continues iteratively, denoising the motion step by step until reaching timestep t=0, where the final motion sequence is obtained \hat{x}₀=M(x₁, 1, C) and

$${\hat{x}}_{0} = \{ {\hat{x}}_{0}^{( 1 )} , {\hat{x}}_{0}^{( 2 )} , … , {\hat{x}}_{0}^{( N )} \}$$

are the predicted motions.

At step 903, motion prediction application 146 causes character 160 to move based on the motion generated at step 902. In some embodiments, motion prediction application 146 further uses various trajectory generation or control algorithms, such as model predictive control and/or the like, to process the motion generated at step 902 and generate motions 504 that are actions for causing character 160 to move, as described above in conjunction with FIG. 5B. For example, in some embodiments, motion predict application 146 causes character 160 to move by transmitting the generated motions 504 to a low-level controller (e.g., a PID controller, a PD controller, etc.) of joint actuators of a physical or simulated robot. As another example, in some embodiments, motion prediction application 146 can update the joint positions of a virtual character within a virtual environment based on the generated motions 504.

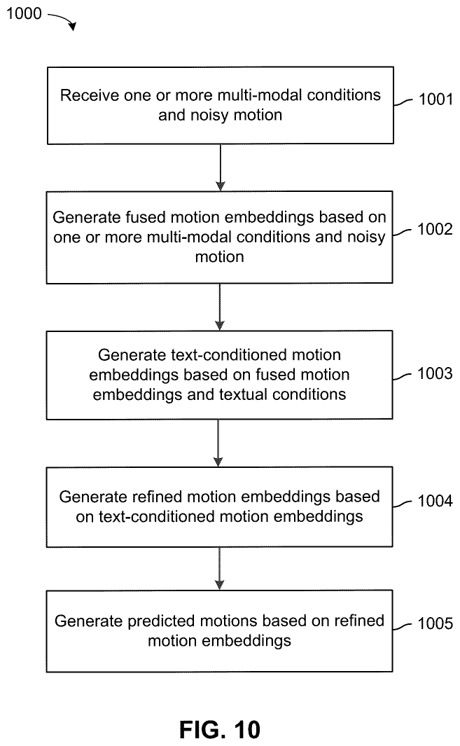

FIG. 10 is a flow diagram of method steps for generating predicted motions 614 using the trained motion generalist model 153 based on multi-modal conditions 503 and noisy motion 601, according to various embodiments. In some embodiments, the method steps for generating predicted motions can be performed during each time step of the single-step or multi-step denoising diffusion at step 802 of method 800 or step 902 of method 900. Although the method steps are described in conjunction with the systems of FIGS. 1-6, persons skilled in the art will understand that any system configured to perform the method steps in any order falls within the scope of the present disclosure.

As shown, a method 1000 begins with step 1001, where motion generalist model 153 receives one or more multi-modal conditions 503 and noisy motion 601. In some embodiments, motion generalist model 153 receives one or more of multi-modal conditions 503 from one or more I/O devices. In some embodiments, in motion estimation mode, noisy motion 601 includes x-during a single-step denoising diffusion. In some embodiments, in motion generation mode, noisy motion 601 includes any of the xₜ, t=1, . . . , T during a multi-step diffusion.

At step 1002, additive fusion module 604 generates fused motion embeddings 611 based on one or more multi-modal conditions 503 and noisy motion 601. In some embodiments, additive fusion module 604 includes multilayer perceptrons to process video/2D keypoint conditions 602 and generate per-frame motion tokens. Additive fusion module 604 also includes a linear layer to fuse the noisy motion 601 xₜ with per-frame motion tokens to generate fused motion embeddings 611.

At step 1003, multi-text injection module 605 generates text-conditioned motion embeddings 612 based on fused motion embeddings 611 and textual conditions 603. In some embodiments, multi-text injection module 605 processes one or more user inputs (not shown) to specify which textual condition 603 corresponds to which segment of the motion sequence included in video/2D keypoint conditions 602. In some embodiments, multi-text attention module 607 first processes textual conditions 603 by encoding textual conditions 603 into text embeddings τ₁, τ₂, . . . , τᵢ where each τₖ represents the embedding of a textual condition 603. The text embeddings are then used as the keys in a masked multi-head attention operation that conditions the motion feature sequence fᵢₙ included in fused motion embeddings 611. In some embodiments, multi-text attention module 607 applies masked multi-head attention over the motion sequence, permitting that each textual condition 603 influences only the corresponding time window within the motion sequence. In some examples, the masked muti-head attention is performed using a binary mask [symbol] (i, j), which determines whether the textual condition 603 τₖ affects a given motion feature sequence fᵢₙ (i). For example, the text-conditioned motion embeddings 612 can be computed as described by Equations 17 and 18.

At step 1004, RoPE-based transformer 606 generates refined motion embeddings 613 based on text-conditioned motion embeddings 612. In some embodiments, RoPE-based transformer 606 uses RoPE, which encodes relative temporal positions instead of absolute positions, permitting that motion sequences of varying lengths can be processed. Accordingly, methods 800 and 900 can be used to estimate and generate motions of any length, respectively. In various embodiments, RoPE-based transformer 606 uses self-attention mechanisms to process text-conditioned motion embeddings 611 while maintaining the temporal relationships. In some embodiments, RoPE-based transformer 606 computes attention scores based on relative positional relationships to capture the motion dependencies across time while remaining fully compatible with image-conditioned motion generation, such as video-based motion generation.

At step 1005, decoder module 608 generates predicted motions 614 based on refined motion embeddings 613. In various embodiments, decoder module 608 includes a transformer that reconstructs the predicted motions 614 from the refined motion embeddings 613. In some embodiments, predicted motion 614 includes a sequence of poses over time, such as 3D joint positions.

In sum, techniques are disclosed for character motion estimation and generation using a motion generalist model, which is a machine learning model such as a neural network. In various embodiments, a model trainer trains the motion generalist model based on motion data, which includes multimodal conditions, such as video/2D keypoint conditions, noisy motion, and textual condition. The training begins with the model trainer randomly sampling one or more conditions from motion data. Whenever the model trainer determines the sampled conditions do not include video or 2D keypoints (e.g., skeletal representations of human motion derived from video footage), the motion generalist model uses a motion generation mode to generate motions based on the sampled conditions. Whenever the model trainer determines the sampled conditions includes video/2D keypoints, the motion generalist model performs motion estimation based on the sampled conditions. The model trainer then checks whether the sampled conditions include 3D annotations. Whenever the model trainer determines the sampled conditions include 3D annotations, the motion generalist model uses the motion generation mode to generate motions based on the sampled conditions (e.g., video/2D keypoint conditions with 3D annotations). Whenever the model trainer determines the video/2D keypoint conditions does not include 3D annotations, the motion generalist model generates 3D pseudo-labels, using a motion estimation mode, based on video/2D keypoint conditions. The motion generalist model then uses the motion generation mode to generate motions based on the sampled conditions (e.g., video/2D keypoint conditions with the generated pseudo-3D labels). A loss calculation module then calculates a total loss, which includes at least one of an estimation loss and a 3D diffusion loss based on the predicted motions and ground truth motions. The model trainer then iteratively updates the one or more parameters of the motion generalist model based on the total loss until a predefined stopping criterion is met. Once the motion generalist model is trained, the trained motion generalist model can be used to estimate motions and to generate motions for causing a character to move.

In some embodiments, the trained motion generalist model is used to generate motions to cause a character to move. The motion generalist model processes noisy motion (e.g., motion sequences with added randomness) and multi-modal conditions, which can include video/2D keypoint conditions (e.g., video-based references or keypoint-based observations) and a textual conditions (e.g., text descriptions that specify motion characteristics or intent), and/or the like, and the motion generalist model generates predicted motions. The motion generalist model includes an additive fusion module, one or more UNIMFM layers, and a decoder module. Each UNIMFM layer includes a multi-text injection module and a RoPE-based transformer. The additive fusion module processes the multi-modal conditions and noisy motion and generates fused motion embeddings. The multi-text injection module uses a multi-text attention module to process the fused motion embeddings and textual conditions to generate text-conditioned motion embeddings, which integrates the textual conditions into the fused motion embeddings. The ROPE-based transformer processes the text-conditioned motion embeddings and generates refined motion embeddings. The decoder module processes refined motion embeddings and generates the predicted motions which can be used to estimate motions of a character or to generate motions to cause a character to move.

At least one technical advantage of the disclosed techniques relative to the prior art is that the disclosed techniques implement a motion generalist model that is capable of performing both motion estimation and motion generation within a unified framework without requiring separate models for motion estimation and motion generation. The estimated and generated motions can be of any length. Motion generation using the generalist model can also be conditioned on multi-modal conditions over various time windows, while transitioning naturally between the conditions. Another technical advantage of the disclosed techniques is that the motion generalist model can be trained using both 3D motion capture datasets and video/2D keypoint datasets. In addition, the disclosed techniques improve motion estimation accuracy by addressing challenges, such as occlusions, viewpoint variations, incomplete observations, and/or the like, by generating pseudo-3D labels. These technical advantages represent one or more technological improvements over prior art approaches.
1. In some embodiments, a computer-implemented method for training a machine learning model to predict motion comprises estimating, using an untrained machine learning model, a first motion based on at least one first condition, generating, using the untrained machine learning model, a second motion based on at least one second condition, computing a loss based on the first motion, the second motion, and one or more ground truth motions, and updating one or more parameters of the untrained machine learning model based on the loss to generate a trained machine learning model.
2. The computer-implemented method of clause 1, further comprising sampling motion data to generate one or more sampled conditions, wherein the one or more sampled conditions include the at least one first condition and the at least one second condition.
3. The computer-implemented method of clauses 1 or 2, wherein computing the loss comprises computing a first loss based on the first motion and a first ground truth motion included in the one or more ground truth motions, computing a second loss based on the second motion and a second ground truth motion included in the one or more ground truth motions, and computing the loss based on the first loss and the second loss.
4. The computer-implemented method of any of clauses 1-3, wherein the at least one first condition includes at least one of a video condition or a two-dimensional (2D) keypoint condition.
5. The computer-implemented method of any of clauses 1-4, wherein the at least one second condition includes at least one of one or more textual conditions, one or more video conditions, one or more 2D keypoint conditions, one or more three-dimensional (3D) conditions, one or more spoken instructions, or one or more audio conditions.
6. The computer-implemented method of any of clauses 1-5, wherein estimating the first motion is performed in response to determining the at least one first condition includes at least one of one or more videos or one or more 2D conditions.
7. The computer-implemented method of any of clauses 1-6, further comprising, in response to determining the at least one second condition only includes one or more videos or one or more 2D conditions, estimating, using the untrained machine learning model and based on the at least one second condition, a third motion, wherein the one or more ground truth motions include the third motion.
8. The computer-implemented method of any of clauses 1-7, wherein estimating the first motion comprises performing a single denoising diffusion step.
9. The computer-implemented method of any of clauses 1-8, wherein generating the second motion comprises performing a plurality of denoising diffusion steps.
10. The computer-implemented method of any of clauses 1-9, based on at least one video or 2D condition, a third motion using the trained machine learning model, or causing a character to move based on a fourth motion generated using the trained machine learning model and based on one or more multi-modal conditions.
11. In some embodiments, one or more non-transitory computer readable media store instructions that, when executed by one or more processors, cause the one or more processors to perform the steps of estimating, using an untrained machine learning model, a first motion based on at least one first condition, generating, using the untrained machine learning model, a second motion based on at least one second condition, computing a loss based on the first motion, the second motion, and one or more ground truth motions, and updating one or more parameters of the untrained machine learning model based on the loss to generate a trained machine learning model.
12. The one or more non-transitory computer-readable media of clause 11, wherein the instructions, when executed by the one or more processors, further cause the one or more processors to perform the step of sampling motion data to generate one or more sampled conditions, wherein the one or more sampled conditions include the at least one first condition and the at least one second condition.
13. The one or more non-transitory computer-readable media of clauses 11 or 12, wherein estimating the first motion is performed in response to determining the at least one first condition includes at least one of one or more videos or one or more 2D conditions.
14. The one or more non-transitory computer-readable media of any of clauses 11-13, wherein the instructions, when executed by the one or more processors, further cause the one or more processors to perform the step of, in response to determining the at least one second condition only includes one or more videos or one or more 2D conditions, estimating, using the untrained machine learning model and based on the at least one second condition, a third motion, wherein the one or more ground truth motions include the third motion.
15. The one or more non-transitory computer-readable media of any of clauses 11-14, wherein estimating the first motion comprises performing a single denoising diffusion step.
16. The one or more non-transitory computer-readable media of any of clauses 11-15, wherein generating the second motion comprises performing a plurality of denoising diffusion steps.
17. The one or more non-transitory computer-readable media of any of clauses 11-16, wherein computing the loss comprises computing at least one of (i) a geometric loss, (ii) an estimation loss based on a difference between the first motion and a first ground truth motion included in the one or more ground truth motions, (iii) a 2D projection loss based on a difference between a 2D re-projection of a third motion generated using the untrained machine learning model and a 2D re-projection of a second ground truth motion included in the one or more ground truth motions, or (iv) a 3D diffusion loss based on a difference between the second motion and a third ground truth motion included in the one or more ground truth motions.
18. The one or more non-transitory computer-readable media of any of clauses 11-17, wherein computing the estimation loss comprises projecting the first motion to two dimensions.
19. The one or more non-transitory computer-readable media of any of clauses 11-18, wherein each condition included in the at least one second condition is associated with a corresponding time window.
20. In some embodiments, a system comprises one or more memories storing instructions, and one or more processors that are coupled to the one or more memories and, when executing the instructions, are configured to estimate, using an untrained machine learning model, a first motion based on at least one first condition, generate, using the untrained machine learning model, a second motion based on at least one second condition, compute a loss based on the first motion, the second motion, and one or more ground truth motions, and update one or more parameters of the untrained machine learning model based on the loss to generate a trained machine learning model.
1. In some embodiments, a computer-implemented method for controlling a character comprises receiving one or more conditions, based on the one or more conditions, generating or estimating a motion using a trained machine learning model, wherein the trained machine learning model is configured to estimate the motion via one denoising diffusion step or generate the motion via a plurality of denoising diffusion steps, and causing the character to move based on the motion.
2. The computer-implemented method of clause 1, wherein the one or more conditions include at least one video or two-dimensional (2D) condition, and estimating the motion comprises generating a noisy motion, and performing the one denoising diffusion step to estimate the motion using the trained machine learning model and based on the noisy motion and the at least one video or 2D condition.
3. The computer-implemented method of clauses 1 or 2, wherein the one or more conditions include one or more multi-modal conditions, and generating the motion comprises generating a noisy motion, and performing the plurality of diffusion denoising steps to generate the motion using the trained machine learning model and based on the noisy motion and the one or more multi-modal conditions.
4. The computer-implemented method of any of clauses 1-3, wherein causing the character to move comprises generating another motion based on the motion, and controlling the character based on the another motion.
5. The computer-implemented method of any of clauses 1-4, wherein generating the motion comprises receiving a noisy motion, generating, based on the noisy motion and at least one video or two-dimensional (2D) condition included in the one or more conditions, one or more fused motion embeddings using an additive diffusion module included in the trained machine learning model, generating, based on the one or more fused motion embeddings and one or more textual conditions included in the one or more conditions, one or more refined motion embeddings using one or more layers included in the trained machine learning model, generating, based on the one or more refined motion embeddings, a predicted motion using a decoder included in the trained machine learning model, and generating, based on the predicted motion, the motion.
6. The computer-implemented method of any of clauses 1-5, wherein generating the one or more fused motion embeddings using the additive diffusion module comprises generating, based on the at least one video or 2D condition, one or more per-frame motion tokens using one or more multi-layer perceptrons, and generating, based on the one or more per-frame motion tokens, the one or more fused motion embeddings using a linear layer.
7. The computer-implemented method of any of clauses 1-6, wherein generating the one or more refined motion embeddings using the one or more layers comprises generating, based on the one or more fused motion embeddings and the one or more textual conditions, one or more text-conditioned motion embeddings using a multi-text injection module, and generating, based on the one or more text-conditioned motion embeddings, the one or more refined motion embeddings using a transformer included in the trained machine learning model.
8. The computer-implemented method of any of clauses 1-7, wherein generating the one or more refined motion embeddings using the one or more layers comprises processing one or more user inputs to specify which of the one or more textual conditions corresponds to which segment of a motion sequence included in the at least one video or 2D condition.
9. The computer-implemented method of any of clauses 1-8, wherein generating the one or more refined motion embeddings using the one or more layers comprises generating, based on the one or more one textual conditions, one or more text embeddings using a multi-text attention module, performing one or more masked multi-head attention operations using the multi-text attention module to generate one or more binary masks based on the one or more text embeddings and the one or more fused motion embeddings, generating, based on the one or more binary masks, the one or more text-conditioned motion embeddings, and generating, based on the one or more text-conditioned motion embeddings, the one or more refined motion embeddings using the transformer included in the trained machine learning model.
10. The computer-implemented method of any of clauses 1-9, wherein generating the motion comprises generating, based on one or more multi-modal conditions included in the one or more conditions, one or more predicted motions using the trained machine learning model, and generating, based on the one or more predicted motions, the motion.
11. In some embodiments, one or more non-transitory computer readable media store instructions that, when executed by one or more processors, cause the one or more processors to perform the steps of receiving one or more conditions, based on the one or more conditions, generating or estimating a motion using a trained machine learning model, wherein the trained machine learning model is configured to estimate the motion via one denoising diffusion step or generate the motion via a plurality of denoising diffusion steps, and causing a character to move based on the motion.
12. The one or more non-transitory computer-readable media of clause 11, wherein the one or more conditions include at least one video or two-dimensional (2D) condition, and estimating the motion comprises generating a noisy motion, and performing the one denoising diffusion step to estimate the motion using the trained machine learning model and based on the noisy motion and the at least one video or 2D condition.
13. The one or more non-transitory computer-readable media of clauses 11 or 12, wherein the one or more conditions include one or more multi-modal conditions, and generating the motion comprises generating a noisy motion, and performing the plurality of diffusion denoising steps to generate the motion using the trained machine learning model and based on the noisy motion and the one or more multi-modal conditions.
14. The one or more non-transitory computer-readable media of any of clauses 11-13, wherein generating the motion comprises receiving a noisy motion, generating, based on the noisy motion and at least one video or 2D condition included in the one or more conditions, one or more fused motion embeddings using an additive diffusion module included in the trained machine learning model, generating, based on the one or more fused motion embeddings and one or more textual conditions included in the one or more conditions, one or more refined motion embeddings using one or more layers included in the trained machine learning model, generating, based on the one or more refined motion embeddings, a predicted motion using a decoder included in the trained machine learning model, and generating, based on the predicted motion, the motion.
15. The one or more non-transitory computer-readable media of any of clauses 11-14, wherein generating the one or more fused motion embeddings using the additive diffusion module comprises generating, based on the at least one video or 2D condition, one or more per-frame motion tokens using one or more multi-layer perceptrons, and generating, based on the one or more per-frame motion tokens, the one or more fused motion embeddings using a linear layer.
16. The one or more non-transitory computer-readable media of any of clauses 11-15, wherein generating the one or more refined motion embeddings using the one or more layers comprises generating, based on the one or more fused motion embeddings and the one or more textual conditions, one or more text-conditioned motion embeddings using a multi-text injection module, and generating, based on the one or more text-conditioned motion embeddings, the one or more refined motion embeddings using a transformer included in the trained machine learning model.
17. The one or more non-transitory computer-readable media of any of clauses 11-16, wherein generating the motion comprises generating, based on one or more multi-modal conditions included in the one or more conditions, one or more predicted motions using the trained machine learning model, and generating, based on the one or more predicted motions, the motion using at least one of one or more control techniques or one or more trajectory generation techniques.
18. The one or more non-transitory computer-readable media of any of clauses 11-17, wherein the one or more conditions include at least one of one or more textual conditions, one or more video conditions, one or more 2D keypoint conditions, one or more three-dimensional (3D) conditions, one or more spoken instructions, or one or more audio conditions.
19. The one or more non-transitory computer-readable media of any of clauses 11-18, wherein each condition included in the one or more conditions is associated with a corresponding time window.
20. In some embodiments, a system comprises one or more memories storing instructions, and one or more processors that are coupled to the one or more memories and, when executing the instructions, are configured to receive one or more conditions, based on the one or more conditions, generate or estimate a motion using a trained machine learning model, wherein the trained machine learning model is configured to estimate the motion via one denoising diffusion step or generate the motion via a plurality of denoising diffusion steps, and cause the character to move based on the motion.

Any and all combinations of any of the claim elements recited in any of the claims and/or any elements described in this application, in any fashion, fall within the contemplated scope of the present disclosure and protection.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model to predict motion, the method comprising:
estimating, using an untrained machine learning model, a first motion based on at least one first condition;
generating, using the untrained machine learning model, a second motion based on at least one second condition;
computing a loss based on the first motion, the second motion, and one or more ground truth motions; and
updating one or more parameters of the untrained machine learning model based on the loss to generate a trained machine learning model.

2. The computer-implemented method of claim 1, further comprising:
sampling motion data to generate one or more sampled conditions, wherein the one or more sampled conditions include the at least one first condition and the at least one second condition.

3. The computer-implemented method of claim 1, wherein computing the loss comprises:
computing a first loss based on the first motion and a first ground truth motion included in the one or more ground truth motions;
computing a second loss based on the second motion and a second ground truth motion included in the one or more ground truth motions; and
computing the loss based on the first loss and the second loss.

4. The computer-implemented method of claim 1, wherein the at least one first condition includes at least one of a video condition or a two-dimensional (2D) keypoint condition.

5. The computer-implemented method of claim 1, wherein the at least one second condition includes at least one of one or more textual conditions, one or more video conditions, one or more 2D keypoint conditions, one or more three-dimensional (3D) conditions, one or more spoken instructions, or one or more audio conditions.

6. The computer-implemented method of claim 1, wherein estimating the first motion is performed in response to determining the at least one first condition includes at least one of one or more videos or one or more 2D conditions.

7. The computer-implemented method of claim 1, further comprising, in response to determining the at least one second condition only includes one or more videos or one or more 2D conditions, estimating, using the untrained machine learning model and based on the at least one second condition, a third motion, wherein the one or more ground truth motions include the third motion.

8. The computer-implemented method of claim 1, wherein estimating the first motion comprises performing a single denoising diffusion step.

9. The computer-implemented method of claim 1, wherein generating the second motion comprises performing a plurality of denoising diffusion steps.

10. The computer-implemented method of claim 1 further comprising at least one of:
estimating, based on at least one video or 2D condition, a third motion using the trained machine learning model; or
causing a character to move based on a fourth motion generated using the trained machine learning model and based on one or more multi-modal conditions.

11. One or more non-transitory computer-readable media storing instructions that, when executed by one or more processors, cause the one or more processors to perform the steps of:
estimating, using an untrained machine learning model, a first motion based on at least one first condition;
generating, using the untrained machine learning model, a second motion based on at least one second condition;
computing a loss based on the first motion, the second motion, and one or more ground truth motions; and
updating one or more parameters of the untrained machine learning model based on the loss to generate a trained machine learning model.

12. The one or more non-transitory computer-readable media of claim 11, wherein the instructions, when executed by the one or more processors, further cause the one or more processors to perform the step of sampling motion data to generate one or more sampled conditions, wherein the one or more sampled conditions include the at least one first condition and the at least one second condition.

13. The one or more non-transitory computer-readable media of claim 11, wherein estimating the first motion is performed in response to determining the at least one first condition includes at least one of one or more videos or one or more 2D conditions.

14. The one or more non-transitory computer-readable media of claim 11, wherein the instructions, when executed by the one or more processors, further cause the one or more processors to perform the step of, in response to determining the at least one second condition only includes one or more videos or one or more 2D conditions, estimating, using the untrained machine learning model and based on the at least one second condition, a third motion, wherein the one or more ground truth motions include the third motion.

15. The one or more non-transitory computer-readable media of claim 11, wherein estimating the first motion comprises performing a single denoising diffusion step.

16. The one or more non-transitory computer-readable media of claim 11, wherein generating the second motion comprises performing a plurality of denoising diffusion steps.

17. The one or more non-transitory computer-readable media of claim 11, wherein computing the loss comprises computing at least one of (i) a geometric loss, (ii) an estimation loss based on a difference between the first motion and a first ground truth motion included in the one or more ground truth motions, (iii) a 2D projection loss based on a difference between a 2D re-projection of a third motion generated using the untrained machine learning model and a 2D re-projection of a second ground truth motion included in the one or more ground truth motions, or (iv) a 3D diffusion loss based on a difference between the second motion and a third ground truth motion included in the one or more ground truth motions.

18. The one or more non-transitory computer-readable media of claim 17, wherein computing the estimation loss comprises projecting the first motion to two dimensions.

19. The one or more non-transitory computer-readable media of claim 11, wherein each condition included in the at least one second condition is associated with a corresponding time window.

20. A system comprising:
one or more memories storing instructions, and
one or more processors that are coupled to the one or more memories and, when executing the instructions, are configured to:
estimate, using an untrained machine learning model, a first motion based on at least one first condition,
generate, using the untrained machine learning model, a second motion based on at least one second condition,
compute a loss based on the first motion, the second motion, and one or more ground truth motions, and
update one or more parameters of the untrained machine learning model based on the loss to generate a trained machine learning model.
